(19) United States
(12) Patent Application Publication
(10) Pub. No.: US 2013/0214054 A1
(43) Pub. Date: Aug. 22, 2013

(54) GENERATOR APPARATUS FOR PRODUCING VORTEX RINGS ENTRAINED WITH CHARGED PARTICLES

(71) Applicant: BATTELLE MEMORIAL INSTITUTE, (US)

(72) Inventors: Lynn L. Faulkner, Westerville, OH (US); James E. Dvorsky, Plain City, OH (US)

(73) Assignee: BATTELLE MEMORIAL INSTITUTE, Columbus, OH (US)

(21) Appl. No.: 13/762,954

(22) Filed: Feb. 8, 2013

Related U.S. Application Data
(60) Provisional application No. 61/596,800, filed on Feb. 9, 2012.

(51) Int. Cl. B05B 5/03; F15D 1/00; B05B 5/16

(52) U.S. Cl. CPC B05B 5/03; B05B 5/16; F15D 1/009
USPC 239/3; 239/699; 239/706; 137/811

(57) ABSTRACT

A process is provided for dispersing suspended particles in the air comprising: providing a generator apparatus for producing one or more propagating fluid vortex rings transporting ionized particles; directing the generator apparatus in a direction toward suspended particles in the air to be dispersed; generating a fluid vortex ring transporting ionized particles using the generator apparatus such that the fluid vortex ring travels to the suspended particles resulting in at least a portion of the ionized particles engaging and applying a charge to at least a portion of the suspended particles. The charged suspended particles are then attracted to one another or to nearby surfaces.

### CROSS REFERENCE TO RELATED APPLICATION

This application claims the benefit of U.S. Provisional Patent Application Ser. No. 61/596,800, filed Feb. 9, 2012 entitled “GENERATOR APPARATUS FOR PRODUCING VORTEX RINGS ENTRAINED WITH CHARGED PARTICLES”, the disclosure of which is hereby incorporated by reference.

### BACKGROUND OF THE INVENTION

U.S. Patent Application Publication No. 2010/0015879 A1 discloses a vortex ring gun. Operation of the vortex ring gun causes the production and propulsion of a vortex ring of fluid from a nozzle of the gun.

### SUMMARY OF THE INVENTION

In accordance with a first aspect of the present invention, a process is provided for dispersing suspended particles in the air comprising: providing a generator apparatus for producing one or more propagating fluid vortex rings transporting ionized particles; directing the generator apparatus in a direction toward suspended particles in the air to be dispersed; generating a fluid vortex ring transporting ionized particles using the generator apparatus such that the fluid vortex ring travels to the suspended particles resulting in at least a portion of the ionized particles engaging and applying a charge to at least a portion of the suspended particles. The charged suspended particles are then attracted to one another or to nearby surfaces.

The suspended particles may comprise one or more of dust particles, smoke particles, pollutants and vapors.

The ionized particles may comprise one of ions, vapor particles, liquid particles and solid particles.

In accordance with a second aspect of the present invention, a generator apparatus is provided for producing a propagating fluid vortex ring comprising: a main structure defining an internal chamber having an exit; structure for generating a force to effect movement of a pulse of fluid through the chamber such that the fluid pulse forms a vortex ring of fluid; and energy supply structure for creating ionized particles. The energy supply structure may be positioned relative to the main structure such that the fluid vortex ring transports ionized particles.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 illustrates a generator apparatus constructed in accordance with a first embodiment of the present invention for producing one or more fluid vortex rings;

FIG. 2 illustrates a generator apparatus constructed in accordance with a second embodiment of the present invention for producing one or more fluid vortex rings;

FIG. 3 illustrates a generator apparatus constructed in accordance with a third embodiment of the present invention for producing one or more fluid vortex rings;

FIG. 4 illustrates a generator apparatus constructed in accordance with a fourth embodiment of the present invention for producing one or more fluid vortex rings;

FIG. 4A is a further view of a serrated sheet metal ring shown in FIG. 4;

FIG. 5 illustrates a generator apparatus constructed in accordance with a fifth embodiment of the present invention for producing one or more fluid vortex rings;

FIG. 6 illustrates a generator apparatus constructed in accordance with a sixth embodiment of the present invention for producing one or more fluid vortex rings;

FIG. 6A illustrates a solid wicking element for supplying a liquid to a cylinder internal chamber such as illustrated in FIG. 6;

FIG. 6B illustrates a wicking element provided in a cylinder such as illustrated in FIG. 6;

FIG. 7 illustrates a generator apparatus constructed in accordance with a seventh embodiment of the present invention for producing one or more fluid vortex rings;

FIG. 8 illustrates a generator apparatus constructed in accordance with an eighth embodiment of the present invention for producing one or more fluid vortex rings; and

FIG. 9 illustrates an alternative cylinder for use in a generator apparatus for producing one or more fluid vortex rings.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

The present invention is directed to a generator apparatus for producing one or more propagating fluid vortex rings, each entrained with ionized particles. The term “ionized particles,” as used herein, is intended to encompass electrically charged ions, electrically charged vapor particles, electrically charged liquid particles and/or electrically charged solid particles. Moreover, the term “ionized ring” refers to a fluid vortex ring entrained with ionized particles. The generator apparatus may comprise a battery powered, portable hand-held apparatus so as to be easily carried, for example, by a firefighter for use in dispersing smoke in a smoke-filled space. The generator may also comprise a stationary generator apparatus, powered either by one or more batteries or by line power received via coupling structure forming part of the generator apparatus for connection to an outlet for providing the line power to the generator apparatus. It is believed that the generator apparatus may be used to disperse particles, such as smoke, pollutants, vapors, dust and the like, in architectural spaces where traditional dispersion techniques do not work well, such as in long or tall structures/volumes having high length-to-width ratios or high height-to-width ratios. Examples of long or tall structures/volumes may include hallways, tunnels, silos, open areas and the like. An “architectural space” may include a room, hallway or the like within a building or structure or an open area outside of a building or a structure.

In the case of dispersing smoke in a smoke-filled space, the generator apparatus of the present invention is advantageous as it is believed to allow a firefighter to be positioned away from the smoke-filled space, e.g., a room, and directionally aim and launch ionized vortex rings into the smoke-filled space to effectively clear the space of smoke. As each ionized ring propagates into or through a space, the ionized particles are dispersed. It is believed that the rate at which the ionized particles disperse can be varied depending upon the amount of net charge included in each vortex ring. Hence, a minimal amount of net charge may result in the vortex ring staying generally intact until airflow dynamics cause it to lose its geometry, while an over-abundance of net charge may cause the ring to readily lose its geometry as the like charges within the vortex ring push away from each other. As ionized particles migrate from a vortex ring, it is believed that the ionized particles contact and interact with suspended particles, such as dust, smoke, vapors, that may be in the path of the vortex ring causing the suspended particles to be electrically charged. The charged suspended particles may migrate to nearby surfaces, such as floors, walls, objects and the like and are attracted to the surfaces through induced charging of the surface. The charged suspended particles, if oppositely charged, may be attracted to one another, resulting in larger suspended particles than may fall to the floor via gravity.

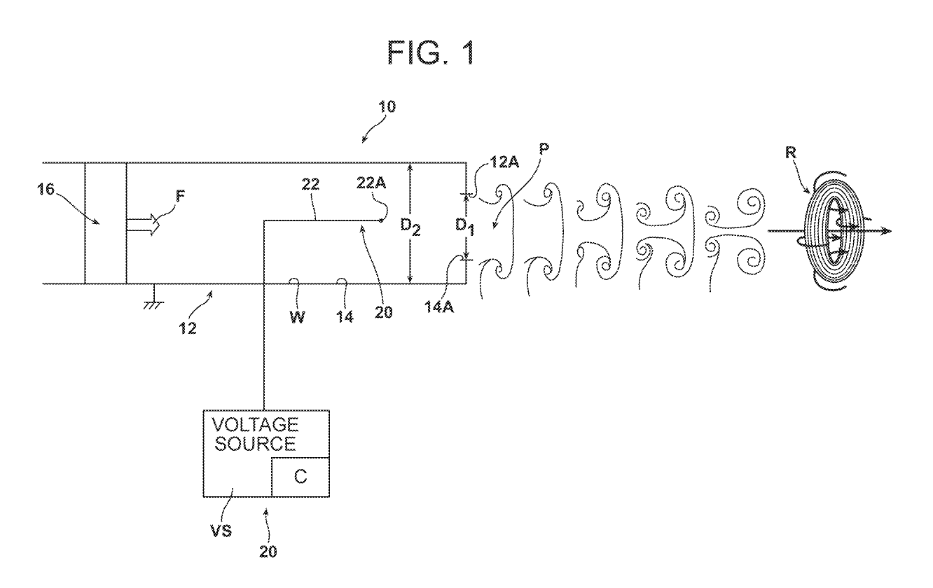

A generator apparatus 10 constructed in accordance with a first embodiment of the present invention for producing one or more fluid vortex rings entrained with ionized particles is illustrated in FIG. 1. The apparatus 10 comprises a main structure comprising a cylinder 12 in the illustrated embodiment. The cylinder 12 defines an internal chamber 14 having an exit 14A. In the FIG. 1 embodiment, the internal chamber 14 has a generally constant diameter along substantially its entire extent. The exit 14A is defined by an orifice 12A in the cylinder 12. The orifice 12A has a diameter D₁ which is less than a diameter D₂ of the internal chamber 14. In the illustrated embodiment, a piston 16 is provided in the cylinder 12 for generating a force F sufficient to effect movement of a fluid pulse P, i.e., an air pulse, through the chamber 14. A flexible diaphragm or bladder, or an explosive reaction may be used in place of the piston to generate the force. As is known in the prior art, due to the velocity of the fluid pulse P, the shape of the internal chamber 14 and the orifice 12A and the interaction of the fluid pulse P with ambient air downstream from the chamber exit 14A, the fluid pulse P evolves into a propagating fluid vortex ring R, see FIG. 1.

In accordance with the present invention, the generator apparatus 10 further comprises an energy supply structure 20 for creating electrically charged or ionized particles. In the FIG. 1 embodiment, the energy supply structure 20 comprises an ionizing electrode 22 generally centered within the internal chamber 14, but may be located near or on an interior cylinder wall W defining the internal chamber 14. The energy supply structure 20 further comprises a voltage source VS coupled to the ionizing electrode 22. The voltage source VS may comprise a high voltage generator powered by a battery. The high voltage generator acts to multiply the voltage provided by the battery to provide voltage sufficient to generate an intense electric field near an end 22A of the ionizing electrode 22. The voltage source VS may be referenced to earth or ground. Depending on the polarity of the applied voltage, electrons and negative ions or positive ions are created from the air in the vicinity of the intense electric field. It may be preferred to apply a voltage having a negative polarity since it has far less corona wind associated with it as compared to a voltage having a positive polarity. Typically, it may be preferred to apply DC potentials to the electrode 22 to create ions of a single polarity. However, an AC voltage may be applied to alternatively generate charged ions of both polarities.

It may be preferred that the cylinder 12 be made from or at least partially coated on its interior wall W with an electrically conductive or semi-conductive material and be electrically coupled to ground to prevent charge from building up on the cylinder 12. Coupling the cylinder 12 to ground may also enhance electric field formation at the electrode 22.

As the fluid pulse P moves through the internal chamber 14, charged ions generated by the energy supply structure 20 are captured and transported by the moving fluid pulse P. Hence, as the fluid pulse P forms into a fluid vortex ring R, the charged ions are incorporated into the fluid vortex ring R forming an ionized ring.

A trigger or switch (not shown) may be provided on the generator apparatus 10. Actuation of the trigger by an operator causes the piston 16 and the energy supply structure 20 to be activated such that an ionized ring R is generated. The voltage source VS may further comprise a control C for varying a magnitude of ionizing current provided to the electrode 22 and/or the time period during which ionizing current is provided to the electrode 22 after the trigger is actuated by a user and before the piston 16 is activated. By varying the magnitude of the ionizing current provided to the electrode 22 and/or the time period for providing current to the electrode 22, an amount of charged ions created by the ionizing electrode 22 prior to the piston 16 being activated can be varied as well as the amount of charged ions incorporated into a fluid vortex ring R.

The generator apparatus 10 may be used by an operator positioned away from a space filled with suspended particles to be dissipated to directionally aim and launch vortex rings entrained with charged ions into the space to effectively clear the space of the suspended particles. As each ionized ring propagates into or through a space, the charged ions are dispersed. The amount of charged ions incorporated into an ionized ring can be varied using the control C forming part of the voltage source VS. As charged ions migrate from a vortex ring, the charged ions contact and interact with the suspended particles, such as dust, smoke, vapors, that may be in the path of the vortex ring causing the suspended particles to be electrically charged. It is believed that the charged suspended particles migrate to nearby surfaces, such as floors, walls, objects and the like and induce opposite charges on those surfaces and are subsequently attracted to the surface. If oppositely charged ions are provided, they cause the suspended particles to become oppositely charged. Hence, the oppositely charged suspended particles are attracted to one another, resulting in larger suspended particles that may fall to the floor via gravity.

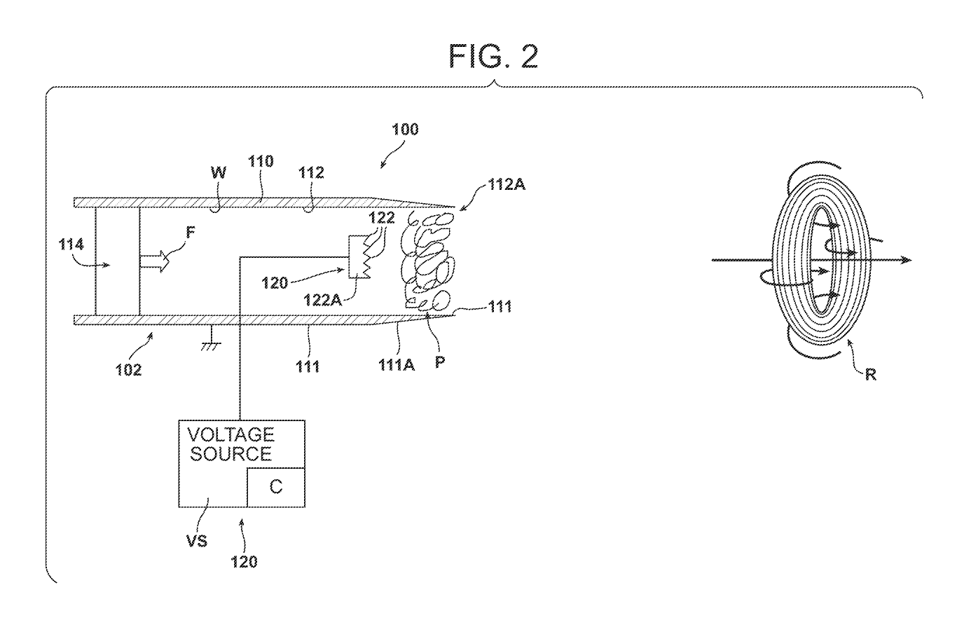

A generator apparatus 100 constructed in accordance with a second embodiment of the present invention for producing one or more ionized fluid vortex rings is illustrated in FIG. 2. The generator apparatus 100 includes a main structure 102 comprising a cylinder 110 in the illustrated embodiment. The cylinder 110 comprises an interior wall W that defines an internal chamber 112 having an exit 112A. In the FIG. 2 embodiment, the internal chamber 112 has a generally constant diameter along substantially its entire extent. The cylinder further comprises an outer wall 111 having a tapered outer surface section 111A near the internal chamber exit 112A. The internal chamber exit 112A is defined by an exit opening 110A in the cylinder 110. The opening 110A has a diameter that is generally equal to the diameter of the internal chamber 112. A piston 114 is provided in the cylinder 110 for generating a force F sufficient to effect movement of a fluid pulse P, i.e., an air pulse, through the chamber 112. A flexible diaphragm or bladder, or an explosive reaction may be used in place of the piston 114 to generate the force. Due to the velocity of the fluid pulse P, the shape of the tapered outer surface section 111A and the opening 110A and the interaction of the fluid pulse P with ambient air downstream from the chamber exit 112A, the fluid pulse P evolves into a propagating fluid vortex ring R, see FIG. 2.

The generator apparatus 100 further comprises an energy supply structure 120 for creating electrically charged particles. In the FIG. 2 embodiment, the energy supply structure 120 comprises a plurality of ionizing electrodes 122 defined by a serrated sheet metal ring 122A generally centered within the internal chamber 112. The energy supply structure 120 further comprises a voltage source VS coupled to the ionizing electrodes 122 for supplying a voltage to each ionizing electrode 122 sufficient to generate an intense electric field near the end of each electrode 122. The voltage source VS comprises generally the same elements as the voltage source VS set out in the FIG. 1 embodiment. Depending on the polarity of the voltage applied to the ionizing electrodes 122, electrons and negative ions or positive ions are created from the air in the vicinity of the intense electric fields.

As the fluid pulse P moves through the internal chamber 112, electrically charged ions generated by the energy supply structure 120 are captured and transported by the moving fluid pulse P. Hence, as the fluid pulse P forms into a fluid vortex ring R, the charged ions are incorporated into the fluid vortex ring R.

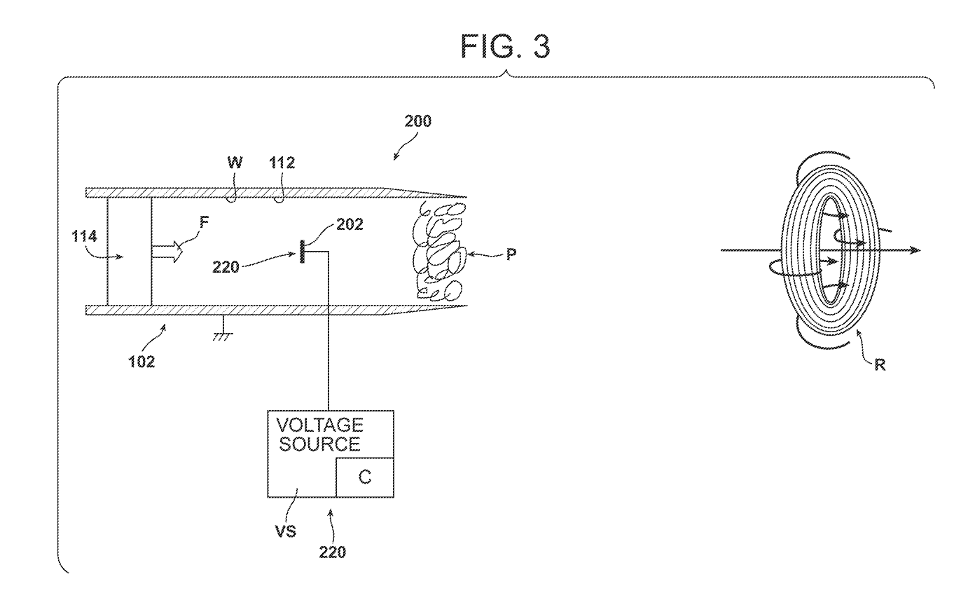

A generator apparatus 200 constructed in accordance with a third embodiment of the present invention for producing one or more ionized fluid vortex rings R is illustrated in FIG. 3. The generator apparatus 200 is constructed in generally the same manner as the generator apparatus 100 set out in FIG. 2, except that the serrated sheet metal ring 122A defining the ionizing electrodes 122 is replaced by a generally circular or ring-shaped corona wire 202. In the illustrated embodiment, the corona wire 202 is spaced from the interior wall W. It is further contemplated that two or more corona wires may be provided.

The generator apparatus 200 further comprises an energy supply structure 220 including a voltage source VS coupled to the corona wire 202 for supplying a voltage to the corona wire 202 sufficient to generate an intense electric field along the entire length of the wire 202. The voltage source VS comprises the generally same elements as the voltage source VS set out in the FIG. 1 embodiment. Depending on the polarity of the voltage applied to the corona wire 202, electrons and negative ions or positive ions are created from the air in the vicinity of the intense electric field generated along the entire length of the wire 202.

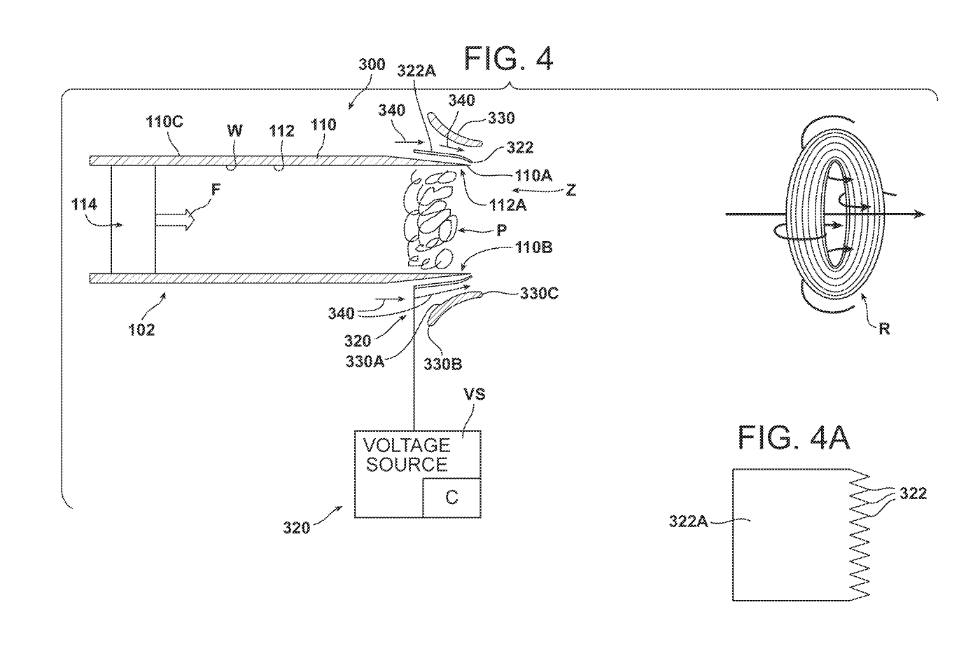

A generator apparatus 300 constructed in accordance with a fourth embodiment of the present invention for producing one or more ionized fluid vortex rings R is illustrated in FIG. 4. The generator apparatus 300 includes a main structure 102 comprising a cylinder 110 constructed in the same manner as the cylinder 110 provided in the embodiment illustrated in FIG. 2.

The generator apparatus 300 further comprises an energy supply structure 320 for creating electrically charged particles. In the FIG. 4 embodiment, the energy supply structure 320 comprises a plurality of ionizing electrodes 322 defined by a serrated sheet metal ring 322A, see FIGS. 4 and 4A. The metal ring 322A is positioned and extends about an end section 110B of the cylinder 110, which is located near the exit opening 110A in the cylinder 110, see FIG. 4. The energy supply structure 120 further comprises a voltage source VS coupled to the sheet metal ring 322A for supplying a voltage to the ionizing electrodes 322 sufficient to generate intense electric fields at the ionizing electrodes 322. The voltage source VS comprises generally the same elements as the voltage source VS set out in the FIG. 2 embodiment. Depending on the polarity of the voltage applied to the ionizing electrodes 322, electrons and negative ions or positive ions are created from the air in the vicinity of the intense electric fields radiating from the electrodes 322.

The generator apparatus 300 further comprises an airflow guide 330 having a generally cylindrical shape with an internal wall 330A that varies in diameter from a first end 330B having a first diameter to a second end 330C having a second diameter, wherein the first diameter is greater than the second diameter and the second end 330C is nearer to the cylinder exit opening 110A than the first end 330B. The airflow guide 330 is positioned about the serrated sheet metal ring 322A in the illustrated embodiment and functions to direct low velocity airflow, designated by arrows 340 in FIG. 4, moving along the outer wall 110C of the cylinder 110 toward the chamber exit 112A or just downstream from the chamber exit 112A, i.e., to the right of the exit 112A in FIG. 4. The airflow guide 330 further functions to channel or direct ions generated by the electrodes 322 toward the chamber exit 112A or just downstream of the chamber exit 112A, wherein the chamber exit 112A or just downstream from the chamber exit 112A is believed to define a zone where a fluid pulse P from the internal chamber 112 forms into a fluid vortex ring R. As the fluid pulse P develops into a fluid vortex ring R, the ions generated by the electrodes 322 and which have been diverted into the fluid vortex ring formation zone Z are incorporated into the fluid vortex ring R.

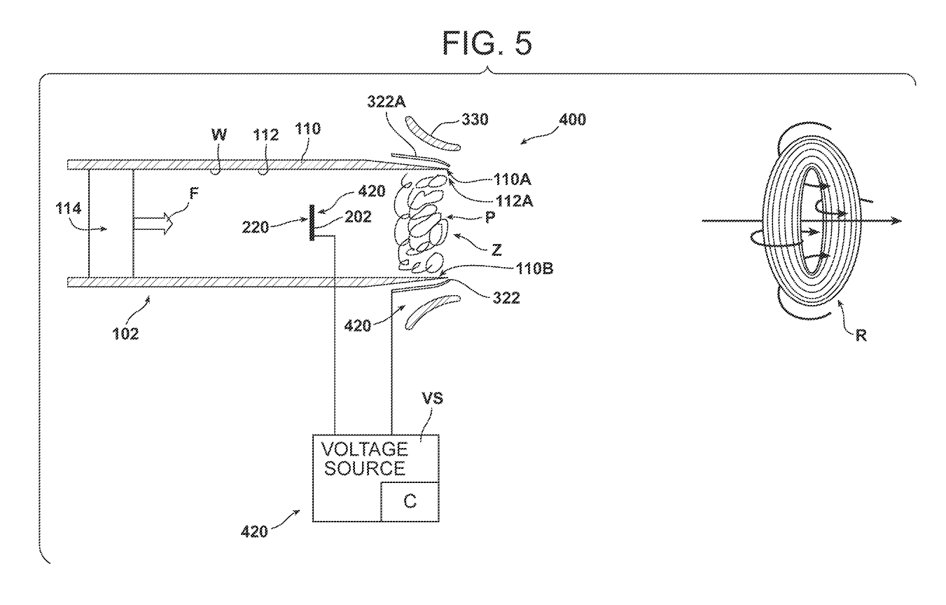

A generator apparatus 400 constructed in accordance with a fifth embodiment of the present invention for producing one or more ionized rings R is illustrated in FIG. 5. The generator apparatus 400 includes a main structure 102 comprising a cylinder 110 constructed in the same manner as the cylinder 110 provided in the embodiment illustrated in FIG. 2.

The generator apparatus 400 further comprises an energy supply structure 420 including a voltage source VS coupled to a corona wire 202 located within the internal chamber 112 and a serrated sheet metal ring 322A defining a plurality of ionizing electrodes 322 positioned about the end section 110B of the cylinder 110. The corona wire 202 is constructed and operates in the same manner as the corona wire 202 provided in the FIG. 3 embodiment and the ionizing electrodes 322 are constructed and may operate in the same manner as the ionizing electrodes 322 provided in the FIG. 4 embodiment. In the illustrated embodiment, the voltage source VS generates a high magnitude positive voltage to the corona wire 202 and a high magnitude negative voltage to the ionizing electrodes 322, with ground or earth being a reference potential between the high magnitude positive and negative potentials. When a positive voltage is provided to the corona wire 202, positive ions are generated by an electric field radiated by the corona wire 202. When a negative voltage is provided to the ionizing electrodes 322, negative ions are generated by the electric fields radiated by the ionizing electrodes 322. Alternatively, the voltage source VS may generate a high magnitude negative voltage to the corona wire 202 and a high magnitude positive voltage to the ionizing electrodes 322. It is further contemplated that the same voltage polarity may be applied to both the corona wire 202 and the ionizing electrodes 322. It is further contemplated, that a high magnitude voltage (having either a negative or positive polarity) may be applied to the corona wire 202 while earth or ground potential is provided to the ionizing electrodes 322. In such an embodiment, ions generated by an electric field radiated by the corona wire 202 will move out of the internal chamber 112 and be in proximity to the ionizing electrodes 322, causing high intensity electric fields to be generated at the ionizing electrodes 322. These fields will be sufficient to ionize surrounding air, resulting in a second set of ions being generated. This second set of ions will have a polarity opposite that of the ions produced by the corona wire 202.

The generator apparatus 400 further comprises an airflow guide 330, which is constructed and functions like the airflow guide 330 provided in the FIG. 4 embodiment.

As a fluid pulse P moves through the internal chamber 112, charged ions generated by the corona wire 202 are captured by the moving fluid pulse P. The airflow guide 330 channels or direct ions generated by the ionizing electrodes 322 toward the chamber exit 112A or just downstream of the chamber exit 112A. After the fluid pulse P leaves the internal chamber 112 with the ions generated by the corona wire 202, it receives the ions generated by the ionizing electrodes 322 which have been diverted into the fluid vortex ring formation zone Z, such that the fluid pulse P forms into a fluid vortex ring R having incorporated therein ions generated by the corona wire 202 and the electrodes 322.

It may be preferred to apply voltages having different polarities to the corona wire 202 and the ionizing electrodes 322 such that positive and negative ions are generated, thereby maintaining a generally net neutral charge environment within a resulting fluid vortex ring R.

It is noted that the shape of the serrated sheet metal ring 322A defining the ionizing electrodes 322 and the airflow guide 330 may be varied from the shapes illustrated in FIGS. 4 and 5, which shapes may be influenced by the shape of the internal chamber 112 and the interaction of the ions generated by the corona wire 202 and/or the ionizing electrodes 322 to themselves and/or with the ions in the environment where the fluid vortex ring R is directed. It is also contemplated that the corona wire 202 may be replaced by the ionizing electrode 22 illustrated in FIG. 1, the ionizing electrode 122 illustrated in FIG. 2 or a ionizing electrode of a different configuration.

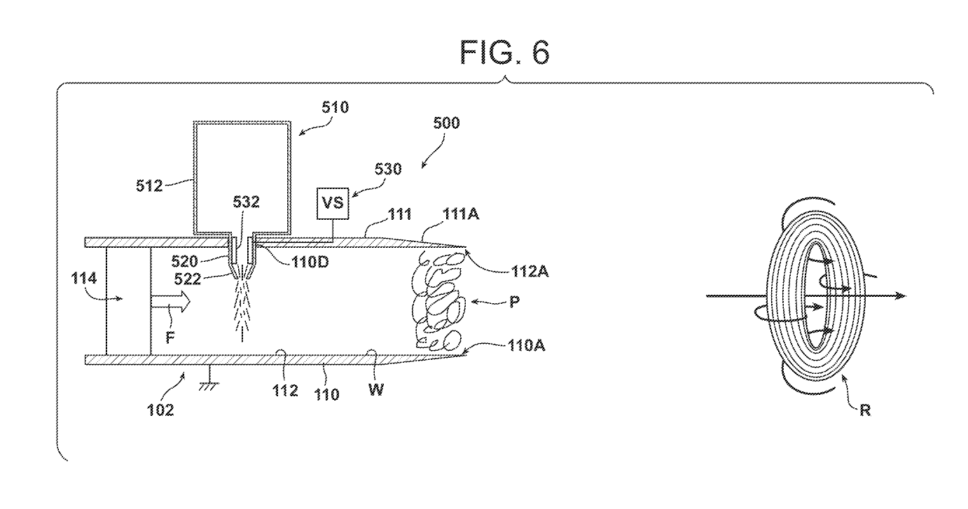

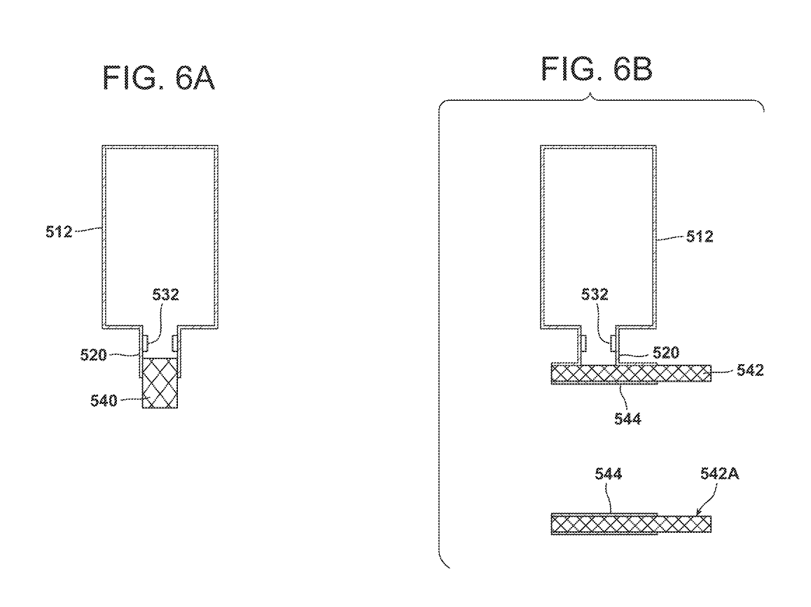

A generator apparatus 500 constructed in accordance with a sixth embodiment of the present invention for producing one or more ionizing fluid vortex rings is illustrated in FIG. 6. The generator apparatus 500 includes a main structure 102 comprising a cylinder 110 in the illustrated embodiment. The cylinder 110 comprises an interior wall W defining an internal chamber 112 having an exit 112A. The internal chamber exit 112A is defined by an exit opening 110A in the cylinder 110. A piston 114 is provided in the cylinder 110 for generating a force F sufficient to effect movement of a fluid pulse P, i.e., an air pulse, through the chamber 112. Due to the velocity of the fluid pulse P, the shape of a tapered outer surface section 111A of the cylinder outer wall 111 and the opening 110A and the interaction of the fluid pulse P with ambient air downstream from the chamber exit 112A, the fluid pulse P evolves into a propagating fluid vortex ring R, see FIG. 6.

The generator apparatus 500 further comprises supply structure 510 comprising in the illustrated embodiment a reservoir 512 for storing a liquid, such as water, glycerin, solubilized polymer in water, perfluorated liquids, commercially available Safety Solvents (Trademark) or other preferably non-combustible fluids. A supply element comprising a conduit 520 extends from the reservoir 512, through a bore 110D in the cylinder 110 into the internal chamber 112. A nozzle 522 defining an exit orifice is provided at the end of the conduit 520. Liquid is supplied by the reservoir 512 to the conduit 520 via gravity, pressure generated by pressurized air supplied to the reservoir 512 and acting on the liquid, or suction feed via a venturi effect caused by the high velocity fluid pulse P moving past the nozzle 522. The liquid passes through the conduit 520 and then the nozzle 522 for delivery into the internal chamber 112. The liquid may be supplied by the nozzle 522 as small liquid droplets or an aerosol. It is also contemplated that the liquid may be in a vapor state when supplied by the nozzle 522.

Alternatively, the supply element may comprise a capillary tube (not shown), which supplies liquid to the internal chamber 110 via capillary action. As the high velocity fluid pulse P moves through the internal chamber 112, it shears fluid from the capillary tube creating aerosol droplets.

The generator apparatus 500 also comprises energy supply structure 530 comprising a high voltage source VS coupled to an electrode 532 positioned on an internal surface of the conduit 520 in the illustrated embodiment. The voltage source VS may generate a DC potential or an AC potential. The conduit 520 in the illustrated embodiment may be formed from an electrically conductive material. Voltage from the high voltage source VS and the electrode 532 is applied to the liquid passing through the conduit 522. Alternatively, the high voltage source VS could be coupled to the reservoir 512 or the nozzle 522, presuming the reservoir 512 or the nozzle 522 is made from an electrically conductive material.

As a fluid pulse P moves through the internal chamber 112, the pulse P transports small liquid droplets, a liquid aerosol or a vapor supplied by the nozzle 522. The small liquid droplets, liquid aerosol or vapor receive either a positive charge or a negative charge when passing through the conduit 520, depending upon the polarity of the high voltage source VS. Thereafter, the fluid pulse P is formed into a fluid vortex ring R, wherein the charged liquid droplets, liquid aerosol or vapor are incorporated into the fluid vortex ring R.

The generator apparatus 500 may be used by an operator positioned away from a space filled with suspended particles to be dissipated to directionally aim and launch vortex rings entrained with charged liquid droplets, liquid aerosol or vapor into the space to effectively clear the space of the suspended particles. As each ionized ring propagates into or through a space, the charged liquid droplets, liquid aerosol or vapor are dispersed. As charged liquid droplets, liquid aerosol or vapor migrate from a propagating vortex ring, the charged liquid droplets, liquid aerosol or vapor contact and interact with the suspended particles, such as dust, smoke, vapors, that may be in the path of the vortex ring causing the suspended particles to be electrically charged. It is believed that the charged suspended particles migrate to surfaces, such as floors, walls, objects and the like and induce opposite charges on those surfaces and are subsequently attracted to the surface. If the charged liquid droplets, liquid aerosol or vapor are oppositely charged, resulting in the charged suspended particles being oppositely charged, the charged suspended particles may be attracted to one another, resulting in larger suspended particles that may fall to the floor via gravity.

It is contemplated that a generally solid cylindrical wicking element 540, formed from a woven fabric chemically compatible with the liquid, may be used in place of the nozzle 522 for supplying a liquid to the internal chamber 112, see FIG. 6A. In the FIG. 6B embodiment, a generally hollow cylindrical wicking element 542 is provided within the cylinder 110. A sheath 544 may encompass most of the wicking element 542 such that a portion 542A of the wicking element 542 extends beyond the sheath 544. As the high velocity fluid pulse P moves through the internal chamber 112 and past the wicking element 542, it shears fluid from the wicking element 540 or the wicking element portion 542A creating aerosol droplets.

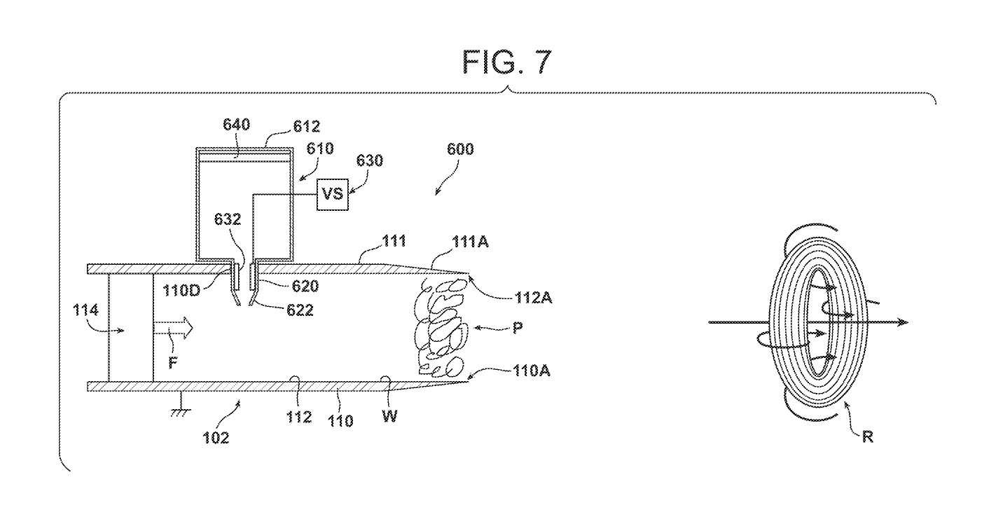

A generator apparatus 600 constructed in accordance with a seventh embodiment of the present invention for producing one or more ionized fluid vortex rings is illustrated in FIG. 7. The generator apparatus 100 includes a main structure 102 comprising a cylinder 110 in the illustrated embodiment. The cylinder 110 comprises an interior wall W defining an internal chamber 112 having an exit 112A. The internal chamber exit 112A is defined by an exit opening 110A in the cylinder 110. A piston 114 is provided in the cylinder 110 for generating a force F sufficient to effect movement of a fluid pulse P, i.e., an air pulse, through the chamber 112. Due to the velocity of the fluid pulse P, the shape of a tapered outer surface section 111A of the cylinder outer wall 111 and the opening 110A and the interaction of the fluid pulse P with ambient air downstream from the chamber exit 112A, the fluid pulse P evolves into a propagating fluid vortex ring R, see FIG. 7.

The generator apparatus 600 further comprises supply structure 610 comprising in the illustrated embodiment a reservoir 612 for storing small solid particles, such as powdered talc, sodium bicarbonate, sodium carbonate, a non-combustible polymer, any of a variety of glass and the like. A supply element comprising a conduit 620 extends from the reservoir 612, through a bore 110D in the cylinder 110 into the internal chamber 112. A nozzle 622 defining an exit orifice is provided at the end of the conduit 620. Solid particles are supplied by the reservoir 612 to the conduit 620 via gravity, pressure generated by pressurized air supplied to the reservoir 512 and acting on the particles, or pressure generated by a reservoir piston or diaphragm 640 located opposite the reservoir conduit 620. The solid particles pass through the conduit 620 and then the nozzle 622 for delivery into the internal chamber 112. It is further envisioned that the operation of the reservoir piston or diaphragm 640 is coordinated with the actuation of the chamber piston 114 so that the solid particles are suspended in the air of the chamber 112 immediately prior to operation of the chamber piston 114.

The generator apparatus 600 further comprises energy supply structure 630 comprising a high voltage source VS coupled to an electrode 632 positioned on an internal surface of the conduit 620 in the illustrated embodiment. The voltage source VS may generate a DC potential or an AC potential. The conduit 620 in the illustrated embodiment may be formed from an electrically conductive material. Voltage from the high voltage source VS and the electrode 632 is applied to the solid particles passing through the conduit 622. Alternatively, the high voltage source VS could be coupled to the reservoir 612 or the nozzle 622, presuming the reservoir 612 or the nozzle 622 is made from an electrically conductive material.

As a fluid pulse P moves through the internal chamber 112, the pulse P transports small solid particles supplied by the nozzle 622. The small solid particles receive either a positive charge or a negative charge when passing through the conduit 620, depending upon the polarity of the high voltage source VS. Thereafter, the fluid pulse P is formed into a fluid vortex ring R, wherein the charged solid particles are incorporated into the fluid vortex R.

In a further embodiment, the supply structure may comprise more than one reservoir. For example, a first reservoir may supply charged liquid droplets, liquid aerosol or vapor to the internal chamber 112 and a second reservoir may supply charged solid particles to the internal chamber 112, such that liquid droplets, liquid aerosol or vapor together with solid particles are incorporated into a fluid vortex ring R.

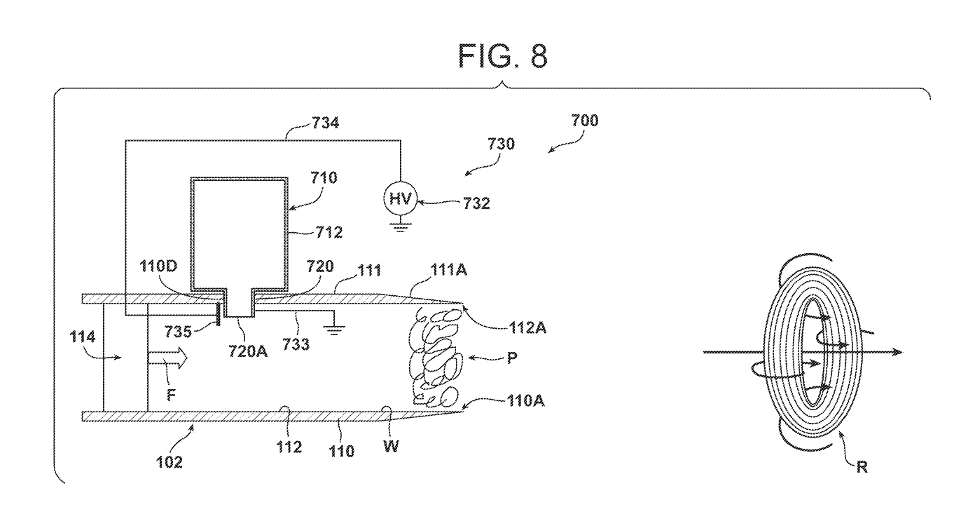

A generator apparatus 700 constructed in accordance with an eighth embodiment of the present invention for producing one or more ionized fluid vortex rings is illustrated in FIG. 8. The generator apparatus 700 includes a main structure 102 comprising a cylinder 110 in the illustrated embodiment. The cylinder 110 comprises an interior wall W defining an internal chamber 112 having an exit 112A. The internal chamber exit 112A is defined by an exit opening 110A in the cylinder 110. A piston 114 is provided in the cylinder 110 for generating a force F sufficient to effect movement of a fluid pulse P, i.e., an air pulse, through the chamber 112. Due to the velocity of the fluid pulse P, the shape of an outer tapered section 111A of the cylinder outer wall 111 and the opening 110A and the interaction of the fluid pulse P with ambient air downstream from the chamber exit 112A, the fluid pulse P evolves into a propagating fluid vortex ring R, see FIG. 8.

The generator apparatus 700 further comprises supply structure 710 comprising in the illustrated embodiment a reservoir 712 for storing a liquid, such as water, glycerin, solubilized polymer in water, perfluorated liquids, commercially available Safety Solvents (Trademark) or other preferably non-combustible fluids. A supply element comprising a conduit or tube 720 extends from the reservoir 712, through a bore 110D in the cylinder 110 into the internal chamber 112. Liquid is supplied to an exit orifice 720A of the tube 720 via gravity, pressure generated by pressurized air supplied to the reservoir 712 and acting on the liquid, or capillary action in tube 720.

The generator apparatus 700 also comprises energy supply structure 730 comprising a high voltage generator 732, a first conductor 733 connecting the tube 720 to earth or ground and a second conductor 734 connecting one or more inducing electrodes 735 to the high voltage generator 732. The one or more electrodes 735 are spaced from the tube exit orifice 720A. In the illustrated embodiment, the one or more inducing electrodes 735 are coupled to a high magnitude potential terminal (either positive or negative) of the high voltage generator, and the tube 720 and the reservoir 712 are coupled to earth or ground. In the illustrated embodiment, the tube 720 and the one or more induction electrodes 735 function to cause an intense electric field to be generated at the tube exit orifice 720A so as to effect electrohydrodynamic comminuting of the liquid supplied to the tube exit orifice 720A.

As a fluid pulse P moves through the internal chamber 112, the pulse P receives a charged liquid aerosol created via the electrohydrodynamic forces (EHD) generated by the energy supply structure 730. Thereafter, the fluid pulse P is formed into a fluid vortex ring R, wherein the charged liquid aerosol is incorporated into the fluid vortex ring R.

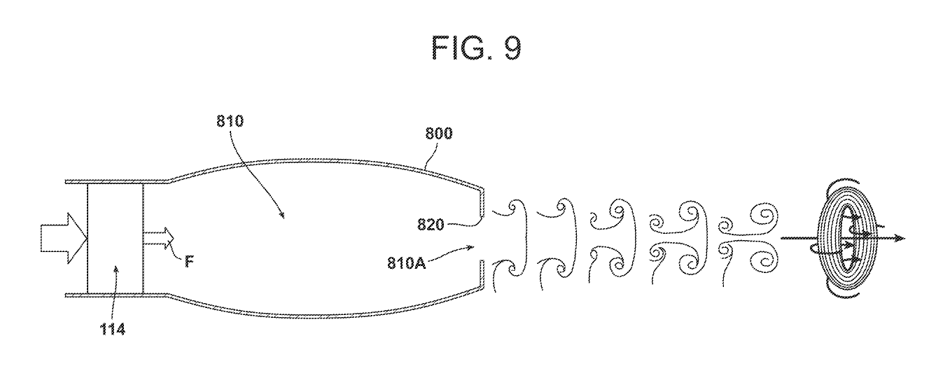

In yet another embodiment illustrated in FIG. 9, a main structure is provided comprising a cylinder 800 having an internal chamber 810 with a diameter that varies along its length. The cylinder 800 further including an orifice 820 defining a chamber exit 810A with a diameter less than the diameter of the internal chamber 810 at any location along the length of the internal chamber 810. The cylinder 800 can be used in place of the cylinder 10 or the cylinder 110 discussed above.

It is further contemplated that the energy supply structure may be provided downstream from the main structure defined, for example, by the cylinder 12 in FIG. 1 or the cylinder 110 in FIG. 2. In such an embodiment, air inside a propagating fluid vortex ring could be ionized downstream after the vortex ring is formed; liquid or solid particles entrained inside the fluid vortex ring could be ionized downstream after the vortex ring with entrained particles is formed; or ionized particles could be introduced to the vortex ring downstream after the fluid vortex ring is formed. Thereafter, the fluid vortex ring functions to transport the ionized particles as the fluid vortex ring propagates. As ionized particles are transported into a space by a fluid vortex ring, it is believed that the ionized particles contact and interact with suspended particles, such as dust, smoke, vapors, that may be in the path of the vortex ring and ionized particles causing the suspended particles to be electrically charged. The charged suspended particles may migrate to nearby surfaces, such as floors, walls, objects and the like and are attracted to the surfaces through induced charging of the surface. The charged suspended particles, if oppositely charged, may be attracted to one another, resulting in larger suspended particles that may fall to the floor via gravity. It is also possible that a liquid or solid particle supply structure in combination with the energy supply structure may be provided downstream from the main structure defined, for example, by the cylinder 12 in FIG. 1 or the cylinder 110 in FIG. 2.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Generator apparatus for producing a propagating fluid vortex ring comprising:
a main structure defining an internal chamber having an exit;
structure for generating a force to effect movement of a pulse of fluid through said chamber such that said fluid pulse forms a vortex ring of fluid; and
energy supply structure for creating ionized particles, said energy supply structure being positioned relative to said main structure such that the fluid vortex ring transports ionized particles.

2. The generator apparatus as set forth in claim 1, wherein said energy supply structure is positioned relative to said main structure such that as the pulse of fluid is formed into a fluid vortex ring, ionized particles are entrained within the fluid vortex ring so as to generate an ionized fluid vortex ring.

3. The generator apparatus as set forth in claim 2, wherein said energy supply structure comprises one or more first ionizing electrodes positioned within said chamber.

4. The generator apparatus as set forth in claim 3, wherein said energy supply structure further comprises a voltage supply source coupled to said one or more ionizing electrodes for generating an ionizing current to said one or more ionizing electrodes, said voltage source comprising a control for varying one or both of a magnitude of said ionizing current provided to said one or more ionizing electrodes and a time period during which ionizing current is provided to said one or more ionizing electrodes before said force generating structure is activated.

5. The generator apparatus as set forth in claim 3, wherein said one or more first ionizing electrodes comprise a serrated sheet metal ring defining a plurality of first ionizing electrodes.

6. The generator apparatus as set forth in claim 3, wherein said energy supply structure further comprises one or more second ionizing electrodes positioned outside of said chamber.

7. The generator apparatus as set forth in claim 6, wherein a polarity of said one or more first ionizing electrodes is different from a polarity of said one or more second ionizing electrodes.

8. The generator apparatus as set forth in claim 6, further comprising an airflow guide located near said chamber exit so as to channel ionized particles generated by said one or more ionizing electrodes positioned outside of said chamber toward a zone of fluid vortex ring formation.

9. The generator apparatus as set forth in claim 2, wherein said energy supply structure comprises a corona wire positioned within said chamber.

10. The generator apparatus as set forth in claim 2, wherein said energy supply structure comprises one or more ionizing electrodes positioned outside said chamber and near said chamber exit such that the ionized particles created by said energy supply structure are entrained with said pulse of fluid just after the pulse of fluid leaves said chamber and forms into a fluid vortex ring.

11. The generator apparatus as set forth in claim 10, further comprising an airflow guide located near said chamber exit so as to channel ionized particles generated by said one or more ionizing electrodes positioned outside said chamber toward a zone of fluid vortex ring formation.

12. The generator apparatus as set forth in claim 2, further comprising liquid supply structure comprising a supply element having an exit orifice located in said chamber such that a liquid is supplied to said exit orifice, said energy supply structure being coupled to said liquid supply structure, wherein as the pulse of fluid moving in said chamber passes said exit orifice it transports liquid leaving said exit orifice, said liquid having an electrical charge acquired from said energy supply structure.

13. The generator apparatus as set forth in claim 12, wherein said supply element comprises a capillary tube.

14. The generator apparatus as set forth in claim 2, further comprising liquid supply structure comprising an exit orifice located in said chamber such that a liquid is supplied to said exit orifice, said energy supply structure being coupled to said liquid supply structure and comprising:
a voltage generator;
a first conductor coupled to said liquid supply structure and ground;
one or more electrodes spaced from said exit orifice and coupled to said voltage generator via a second conductor; and
wherein said one or more electrodes are coupled to a high magnitude potential terminal of said voltage supply source such that said liquid supply structure and said one or more electrodes cause an electric field to be generated at said exit orifice causing electrohydrodynamic comminuting of at least a portion of the liquid supplied to said exit orifice.

15. The generator apparatus as set forth in claim 2, further comprising liquid supply structure comprising a wicking element having a portion located in said chamber such that a liquid is supplied to said portion, said energy supply structure being coupled to said liquid supply structure, wherein as the pulse of fluid moving in said chamber passes said portion it transports liquid, said liquid having an electrical charge acquired from said energy supply structure.

16. The generator apparatus as set forth in claim 2, further comprising solid particle supply structure comprising a delivery portion located in said chamber such that solid particles are supplied to said delivery portion, said energy supply structure being coupled to said solid particle supply structure, wherein as the pulse of fluid moves in said chamber, it entrains solid particles therein, said solid particles having an electrical charge acquired from said energy supply structure.

17. The generator apparatus as set forth in claim 2, wherein said generator apparatus comprises a portable hand-held apparatus and said energy supply structure comprises a battery.

18. The generator apparatus as set forth in claim 2, wherein said energy supply structure comprises coupling structure for connecting to an outlet for providing line power to said energy supply structure.

19. The generator apparatus as set forth in claim 2, wherein said main structure comprises a cylinder having an internal chamber with a generally constant diameter along substantially its entire extent, said internal chamber defining said internal chamber, and said cylinder having a tapered outer surface near said internal chamber exit.

20. The generator apparatus as set forth in claim 2, wherein said main structure comprises a cylinder having an internal chamber with a diameter that varies along its length, said cylinder further including an orifice defining said chamber exit with a diameter less than the diameter of said internal chamber at any location along the length of said internal chamber.

21. The generator apparatus as set forth in claim 2, wherein said main structure comprises a cylinder having an internal chamber with a constant diameter along substantially its entire extent, said internal chamber defining said internal chamber, said cylinder further including an orifice defining said chamber exit with a diameter less than that of said internal chamber.

22. A process for dispersing suspended particles in the air comprising:
providing a generator apparatus for producing one or more propagating fluid vortex rings transporting ionized particles;
directing the generator apparatus in a direction toward suspended particles in the air to be dispersed;
generating a fluid vortex ring transporting ionized particles using the generator apparatus such that the vortex ring travels to the suspended particles resulting in at least a portion of the ionized particles transported by the vortex ring engaging and applying a charge to at least a portion of the suspended particles, the charged suspended particles then being attracted to one another or to a nearby surface.

23. The process as set forth in claim 22, wherein the suspended particles comprises one or more of dust particles, smoke particles, pollutants and vapors.

24. The process as set forth in claim 22, wherein the ionized particles comprises one of ions, vapor particles, liquid particles and solid particles.
